(19) United States
(12) Patent Application Publication
(10) Pub. No.: US 2016/0017898 A1
(43) Pub. Date: Jan. 21, 2016

(54) MERGING CIRCUIT OF HYDRAULIC APPARATUS

(71) Applicant: CATERPILLAR SARL, Geneva (CH)

(72) Inventors: Yuya KANENAWA, Tokyo (JP); Shuhei ORIMOTO, Tokyo (JP); Genta MINE, Tokyo (JP); Yudai ADOMI, Tokyo (JP)

(21) Appl. No.: 14/773,294

(22) PCT Filed: Feb. 27, 2014
(86) PCT No.: PCT/EP2014/025001

§ 371 Date: Sep. 4, 2015

(30) Foreign Application Priority Data
Mar. 6, 2013 (JP) 2013-044117

(51) Int. Cl. F15B 11/16; F15B 21/08

(52) U.S. Cl. CPC F15B 11/165; F15B 21/08; F15B 2211/20576; F15B 2211/255; F15B 2211/405; F15B 2211/426; F15B 2211/6654

(57) ABSTRACT

An object of the present invention is to solve such problems associated with a merging circuit using a pair of spool-type direction switching valves, in that the installation space of a hydraulic valve device increases and the processing that requires accuracy becomes complex. A merging circuit includes a direction switching valve that merges oil discharged from first and second pumps to supply the oil to an actuator; and a controller. The direction switching valve includes a central bypass oil path connected to the discharge oil paths of the first and second pumps, a first parallel supply oil path connected to the discharge oil path of the first pump, and a second parallel supply oil path connected to the discharge oil path of the second pump and connected to a first parallel oil path via a poppet-type flow regulating valve. The poppet-type flow regulating valve regulates the flow rate to a predetermined magnitude according to a signal of the controller.

### CROSS-REFERENCE TO RELATED APPLICATIONS

This application is a National Stage of International Patent Application No. PCT/EP2014/025001, filed Feb. 27, 2014, which claims priority to foreign Japanese Patent Application No. 2013-044117, filed Mar. 6, 2013, the content of which are incorporated herein by reference in their entirety.

### TECHNICAL FIELD

The present invention relates to a merging circuit that merges oil discharged from a plurality of pumps of a hydraulic apparatus to supply the oil to an actuator.

### BACKGROUND

A hydraulic circuit of a boom cylinder that raises and lowers a boom which is, for example, a working arm of a construction machine such as a hydraulic shovel employs a merging circuit configured such that, when oil discharged from pumps is supplied to a head side of a boom cylinder by an operation of a boom switching valve in order to stretch the cylinder and raise the boom, oil discharged from two pumps is merged to increase the supply flow rate so that an operation speed can be increased (for example, see Patent Document 1).

A merging circuit will be described with reference to FIG. 2 (in which reference numerals are assigned to main components of FIG. 1 of Patent Document 1). A first pump 50 and a head side 54 of a boom cylinder 52 are connected by an oil path 56, and a first boom direction switching valve 58 is disposed in the oil path 56. Moreover, a second pump 60 and the oil path 56 are connected by a boom merging oil path 62, and a second boom direction switching valve 64 is disposed in the boom merging oil path 62. The first and second boom direction switching valves 58 and 64 are installed in a valve body 66.

A pressurized pilot oil is supplied to a set of ends close to the respective spools of the first and second boom direction switching valves 58 and 64 through first and second pilot oil paths 68 and 70, respectively, according to an operation from a pilot valve (not illustrated) that is operated by an operator, and the first and second boom direction switching valves 58 and 64 are switched from the neutral position illustrated to a boom stretch position. As a result, the oil discharged from the first pump 50 is supplied to a head side 54 of the boom cylinder 52 through the oil path 56, and the oil discharged from the second pump 60 is supplied to the oil path 56 through the boom merging oil path 62 and merged and added to the oil discharged from the first pump 50. In this way, the boom cylinder 52 is stretched with the increased amount of oil.

Patent Document 1: Japanese Patent No. 2579587 (FIG. 1)

### SUMMARY OF THE DISCLOSURE

The merging circuit of the conventional hydraulic apparatus having the above-described configuration has the following problems to be solved.

That is, the merging circuit of the first and second pumps 50 and 60 uses a pair of direction switching valves 58 and 64 having spools of substantially the same size. Thus, when a plurality of spool-type direction switching valves is included as in a hydraulic shovel including a large number of hydraulic actuators in particular, the installation space of a hydraulic valve device increases and the processing that requires accuracy for the spool becomes complex. Therefore, an improvement is needed from the perspective of space saving, ease of manufacturing, cost reduction, and the like.

With the foregoing in view, it is an object of the present invention to provide a merging circuit of a hydraulic apparatus capable of realizing space saving, ease of manufacturing, cost reduction, and the like by solving such problems associated with a merging circuit using a pair of spool-type direction switching valves having substantially the same size.

In order to solve the problems, according to an aspect of the present invention, there is provided a merging circuit of a hydraulic apparatus, including: a direction switching valve that merges oil discharged from first and second pumps to supply the oil to an actuator; and a controller, wherein the direction switching valve includes: a central bypass oil path which is connected to discharge oil paths of the first and second pumps, passes through a spool at “Neutral Position,” and is closed by the spool at “Operation Position”; a first parallel supply oil path which is connected to the discharge oil path of the first pump and is closed by the spool at “Neutral Position,” and through which the discharged oil is supplied to the actuator via the spool when the spool is switched to “Operation Position”; and a second parallel supply oil path which is connected to the discharge oil path of the second pump and is connected to a first parallel oil path via a poppet-type flow regulating valve that is screwed into and attached to a valve body of the direction switching valve, and the poppet-type flow regulating valve is configured to, according to a signal of the controller based on an operation amount of the spool of the direction switching valve, stop the flow of oil to the first parallel supply oil path using a poppet thereof when the spool is at “Neutral Position,” and allow the flow of oil to the first parallel supply oil path and regulate a flow rate to a predetermined magnitude when the spool is switched from “Neutral Position” to “Operation Position”.

Preferably, the poppet-type flow regulating valve is an electromagnetic proportional flow regulating valve that increases or decreases the flow rate in proportion to a magnitude of the operation amount of the spool.

In the merging circuit of the hydraulic apparatus configured according to the present invention, the direction switching valve that merges the oil discharged from the first and second pumps and supplies the oil to the actuator includes: the central bypass oil path connected to the discharge oil paths of the first and second pumps; the first parallel supply oil path which is connected to the discharge oil path of the first pump and is closed to close the central bypass oil path when the spool is at “Neutral Position” and through which the discharged oil is supplied to the actuator when the spool is switched to “Operation Position”; and the second parallel supply oil path which is connected to the discharge oil path of the second pump and is connected to the first parallel supply oil path via the poppet-type flow regulating valve that is screwed into and attached to the valve body. According to the signal of the controller based on the operation amount of the spool of the direction switching valve, the poppet-type flow regulating valve stops the flow of oil to the first parallel supply oil path with the aid of the poppet when the spool is at “Neutral Position,” allows the flow of oil to the first parallel supply oil path when the spool is at “Operation Position,” and regulates the flow rate to a predetermined magnitude.

Thus, since the merging circuit does not include a pair of spools but includes, in the valve body, one spool valve and one poppet-type flow regulating valve attached by screwing, and can employ a commercial poppet-type flow regulating valve, it is possible to solve such problems associated with the conventional merging circuit including a pair of spools. Therefore, it is possible to realize space saving, ease of manufacturing, cost reduction, and the like

### BRIEF DESCRIPTION OF THE DRAWINGS

FIG. 1 is a diagram of a merging circuit of a hydraulic apparatus configured according to the present invention.

FIG. 2 is a diagram of a conventional merging circuit.

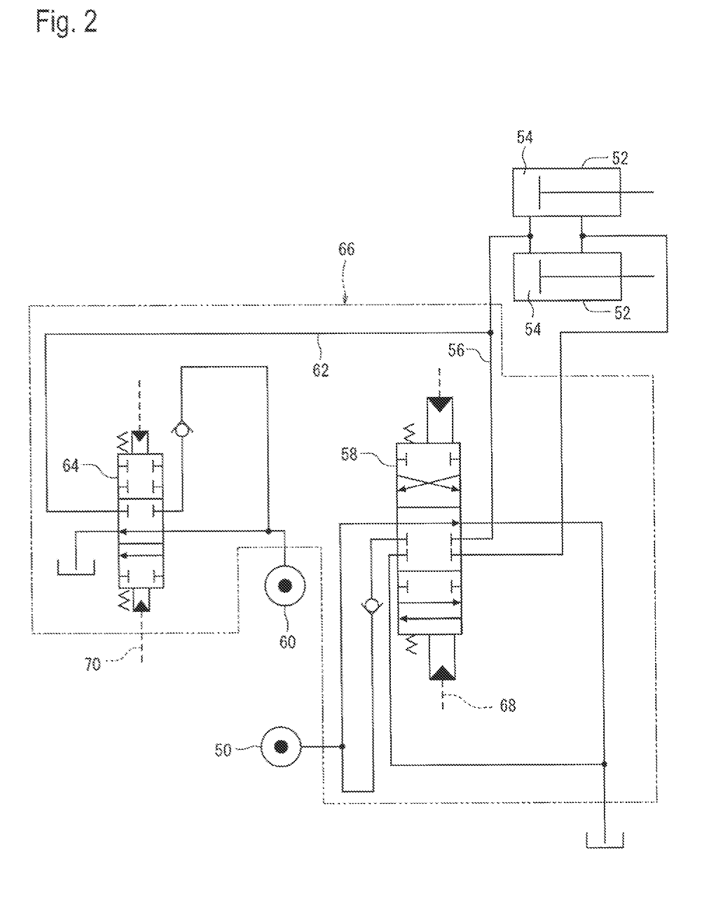

### BEST MODE FOR CARRYING OUT THE INVENTION

Hereinafter, a merging circuit of a hydraulic apparatus configured according to the present invention will be described with reference to the accompanying drawings illustrating a preferred embodiment.

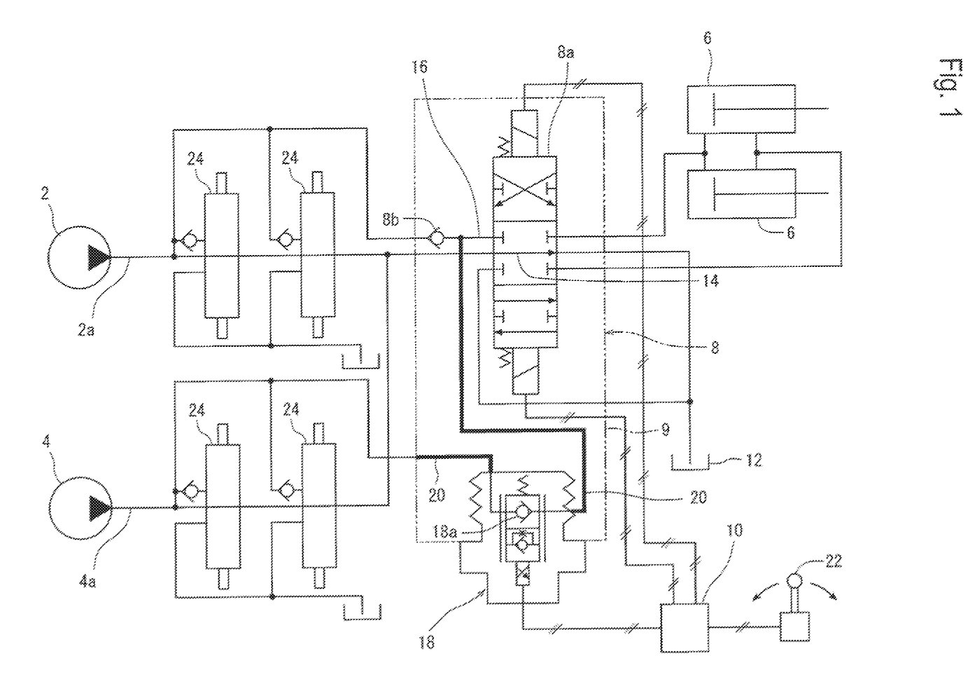

Referring to FIG. 1, a merging circuit includes a direction switching valve 8 that merges oil discharged from first and second pumps 2 and 4 to supply the oil to a pair of double-acting cylinders 6 and a controller 10.

The direction switching valve 8 includes a central bypass oil path 14 which is connected to discharge oil paths 2a and 4a of the first and second pumps 2 and 4, passes through a spool 8a at “Neutral Position” (the illustrated position) to be connected to a tank 12, and is closed by the operated spool 8a at “Operation position.”

Moreover, the direction switching valve 8 includes a first parallel supply oil path 16 which is connected to the discharge oil path 2a of the first pump 2 and is closed by the spool 8a at “Neutral Position,” and through which the discharged oil is supplied to the cylinders 6 via the spool 8a when the spool 8a is switched to “Operation Position,” and a second parallel supply oil path 20 (depicted by bold lines) which is connected to the discharge oil path 4a of the second pump 4 and is connected to the first parallel supply oil path 16 via a poppet-type flow regulating valve 18 that is screwed into and attached to a valve body 9 of the direction switching valve 8.

The first parallel supply oil path 16 includes a known load check valve 8b, and the second parallel supply oil path 20 is connected to the first parallel supply oil path 16 between the load check valve 8b and the spool 8a.

According to a signal from a controller 10 based on an operation amount for completely switching the spool 8a of the direction switching valve 8 from “Neutral Position” to “Operation Position,” the poppet-type flow regulating valve 18 stops the flow of oil to the first parallel supply oil path 16 using a poppet 18a thereof when the spool 8a is at “Neutral Position,” and allows the flow of oil to the first parallel supply oil path 16 and regulates the flow rate to a predetermined magnitude when the spool 8a is switched from “Neutral Position” to “Operation Position”.

The merging circuit will be described in further detail.

The direction switching valve 8 is a known electromagnetic direction switching valve having three positions of “Cylinder Stretch Position,” “Neutral Position,” and “Cylinder Contraction Position”. The position of the spool 8a is changed from the illustrated “Neutral Position” to the respective positions (for example, “Operation Position”) according to the magnitude of an electrical signal input to the controller 10 based on the amount of an operation on an operating lever 22 operated by the operator.

The poppet-type flow regulating valve 18 is an electromagnetic proportional flow regulating valve that is screwed into and attached to a female screw hole formed in the valve body 9. The electrical signal for regulating the flow rate is input from the controller 10 to the electromagnetic proportional flow regulating valve. The electromagnetic proportional flow regulating valve increases or decreases the flow rate in proportion to the magnitude of the electrical signal of the operating lever 22.

As the poppet-type electromagnetic proportional flow regulating valve 18, commercial products sold by the name of “cartridge-type, poppet-type, and threaded-type electromagnetic proportional flow control valves” can be used. Thus, description of detailed structures thereof will not be provided.

The discharge oil paths 2a and 4a of the first and second pumps 2 and 4 each include a plurality of direction switching valves 24 disposed on the upstream side of the direction switching valve 8 so as to operate the operations of various actuators.

The flow of hydraulic oil in the merging circuit of the hydraulic apparatus will be described with reference to FIG. 1.

When direction switching valve is not operated:

In a state (the state of FIG. 1) where the direction switching valve 8 is not operated, the oil discharged from the first and second pumps 2 and 4 flows into the tank 12 through the central bypass oil path 14 of the direction switching valve 8.

When direction switching valve is operated:

When the operating lever 22 is operated to switch the direction switching valve 8 to “Cylinder Stretch Position” or “Cylinder Contraction Position,” the spool 8a is operated according to the operation amount, the central bypass oil path 14 is closed gradually and the first parallel supply oil path 16 is opened gradually so that the oil discharged from the first pump 2 and having passed through the first parallel supply oil path 16 is merged to the oil discharged from the second pump 4 and having passed through the second parallel supply oil path 20 and is supplied to the cylinders 6 via the spool 8a. In this case, the discharged oil flowing through the second parallel supply oil path 20 is regulated by the poppet-type flow regulating valve 18 so that the amount thereof is regulated to be small when the operation amount of the operating lever 22 is small and to be large when the operation amount is large, or is regulated to a predetermined value. After that, the regulated amount of oil flows into the first parallel supply oil path 16.

The advantageous effects of the merging circuit of the hydraulic apparatus will be described.

In the merging circuit of the hydraulic apparatus configured according to the present invention, the direction switching valve 8 that merges the oil discharged from the first and second pumps 2 and 4 and supplies the oil to the actuator 6 includes: the central bypass oil path 14 connected to the discharge oil paths 2a and 4a of the first and second pumps 2 and 4; the first parallel supply oil path 16 which is connected to the discharge oil path 2a of the first pump 2 and is closed to close the central bypass oil path 14 when the spool 8a is at “Neutral Position” and through which the discharged oil is supplied to the actuator 6 when the spool 8a is switched to “Operation Position”; and the second parallel supply oil path 20 which is connected to the discharge oil path 4a of the second pump 4 and is connected to the first parallel supply oil path 16 via the poppet-type flow regulating valve 18 that is screwed into and attached to the valve body 9. According to the signal of the controller 10 based on the operation amount of the spool 8a of the direction switching valve 8, the poppet-type flow regulating valve 18 stops the flow of oil to the first parallel supply oil path 16 with the aid of the poppet 18a when the spool 8a is at “Neutral Position,” allows the flow of oil to the first parallel supply oil path 16 when the spool 8a is at “Operation Position,” and regulates the flow rate to a predetermined magnitude.

Thus, since the merging circuit does not include a pair of spools but includes, in the valve body, one spool valve and one poppet-type flow regulating valve attached by screwing, and can employ a commercial poppet-type flow regulating valve, it is possible to solve such problems associated with the conventional merging circuit including a pair of spools, in that the installation space of the hydraulic valve device increases and the processing that requires accuracy becomes complex. Therefore, it is possible to realize space saving, ease of manufacturing, cost reduction, and the like.

Moreover, since the poppet-type flow regulating valve 18 is an electromagnetic proportional flow regulating valve that increases or decreases the flow rate in proportion to the magnitude of the operation amount of the spool, it is possible to more finely set the flow rate and to improve the operability in such a way that rapid acceleration or deceleration of actuators is prevented.

While the present invention has been described in detail based on the embodiment, the present invention is not limited to the embodiment, but various alterations or modifications as below can be made within the scope of the present invention.

In the embodiment of the present invention, although the direction switching valve 8 is an electromagnetic direction switching valve, the direction switching valve may be a hydraulic pilot-type direction switching valve or a manual direction switching valve.

Moreover, in the embodiment of the present invention, the poppet-type flow regulating valve 18 is an electromagnetic proportional flow regulating valve, the valve may not be an electromagnetic flow regulating valve but may be a flow regulating valve capable of regulating the flow rate to a predetermined value.

### EXPLANATION OF REFERENCE NUMERALS

2: First pump

2a: Discharge oil path

4: Second pump

4a: Discharge oil path

6: Cylinder (Actuator)

8: Direction switching valve

8a: Spool

10: Controller

14: Central bypass oil path

16: First parallel supply oil path

18: Poppet-type flow regulating valve

18a: Poppet

20: Second parallel supply oil path

1. A merging circuit of a hydraulic apparatus, comprising:
a direction switching valve that merges oil discharged from first and second pumps to supply the oil to an actuator; and
a controller, wherein
the direction switching valve includes:
a central bypass oil path which is connected to discharge oil paths of the first and second pumps, passes through a spool at “Neutral Position,” and is closed by the spool at “Operation Position”;
a first parallel supply oil path which is connected to the discharge oil path of the first pump and is closed by the spool at “Neutral Position,” and through which the discharged oil is supplied to the actuator via the spool when the spool is switched to “Operation Position”; and
a second parallel supply oil path which is connected to the discharge oil path of the second pump and is connected to a first parallel oil path via a poppet-type flow regulating valve that is screwed into and attached to a valve body of the direction switching valve, and
the poppet-type flow regulating valve is configured to, according to a signal of the controller based on an operation amount of the spool of the direction switching valve, stop the flow of oil to the first parallel supply oil path using a poppet thereof when the spool is at “Neutral Position,” and allow the flow of oil to the first parallel supply oil path and regulate a flow rate to a predetermined magnitude when the spool is switched from “Neutral Position” to “Operation Position”.

2. The merging circuit of a hydraulic apparatus according to claim 1, wherein
the poppet-type flow regulating valve is an electromagnetic proportional flow regulating valve that increases or decreases the flow rate in proportion to a magnitude of the operation amount of the spool.
